(19) United States
(12) Patent Application Publication
(10) Pub. No.: US 2011/0310502 A1
(43) Pub. Date: Dec. 22, 2011

(54) SPACE OPTICAL SYSTEM HAVING MEANS FOR ACTIVE CONTROL OF THE OPTICS

(75) Inventors: Laurent Blanchard, Mouans-Sartoux (FR); Frédéric Falzon, Pegomas (FR); Arnaud Liotard, Grasse (FR); Guillaume Perrin, La Colle Sur Loup (FR)

(73) Assignee: THALES, NEUILLY-SUR-SEINE (FR)

(21) Appl. No.: 13/131,016

(22) PCT Filed: Nov. 19, 2009
(86) PCT No.: PCT/EP2009/065473

§ 371 Date: Jul. 7, 2011

(30) Foreign Application Priority Data
Nov. 25, 2008 (FR) 0806620

(51) Int. Cl. G02B 7/182

(52) U.S. Cl. 359/850

(57) ABSTRACT

An optical space observation system comprises a primary mirror, a secondary mirror, a supporting base containing the primary mirror, on which a mechanical structure bearing a support of the secondary mirror is positioned, and an optical measurement means, said mechanical structure comprising a plurality of mechanical arms. The system also has a system comprising a plurality of actuators positioned on the supporting base, said actuators being connected to the lower ends of said mechanical arms and the upper ends of said mechanical arms being connected to the support of the secondary mirror on the periphery of the support. A space telescope is intended to be loaded in a launcher and put into orbit. The invention is intended in particular for a telescope having a deployable secondary mirror and means for active control of the optics.

The field of the invention relates to optical systems for space observation and, more particularly, to optical observation systems intended to be loaded on board spacecraft and be deployed in space.

Here, optical systems for space observation are intended to mean telescopes making it possible to obtain high-resolution images for observation of the Earth from space or for deep space observation. These telescopes are for example of the Cassegrain, Gregorian, Korsch, Ritchey-Chrétien or Newtonian type, etc. The optical detectors of a space telescope must be capable of recording images of objects which have very low luminosity, generally requiring exposure times under the limits imposed by the stabilization capacity of the optical system. These applications require the use of space observation systems with ever greater size and higher performance.

Space telescopes are intended to be fitted to satellites intended to be put in orbit. Currently, telescopes are designed to be able to undergo the vibrations of the take-off phase for sending the satellite into space, then the thermoelastic orbital stresses, without significant modifications of the optical adjustments carried out on the ground. These constraints are leading to the design of extremely robust structures employing exotic materials, hyperstable connections and ultraprecise temperature control systems. The consequences of such a design of the structures are high weight and cost.

Furthermore, in the near future, the collecting surface requirements of future observation systems mean that their structures will tend to be deployable. The telescopes mentioned above comprise a primary mirror, a secondary mirror separated from the primary mirror by a selected distance and a supporting base containing the primary mirror, on which a mechanical structure bearing a support of the secondary mirror is positioned. A deployable structure is intended to mean a structure in which the secondary mirror can, in a first configuration, be in a position close to or in contact with the supporting base and, in a second configuration, can be separated from the primary mirror. By virtue of this type of structure, it is possible to reduce the bulk of a satellite when transporting it from the ground to its mission orbit, and consequently to load a larger number of satellites on board the launchers. For these structures, however, a system allowing optical adjustment to be carried out in flight must be envisaged.

To this end, there are telescopes having systems for mechanical adjustment and correction consisting of a hexapod at the interface of the secondary mirror. This hexapod comprises the system of actuators, the control system of the actuators and the supply cabling. Such a solution involves the latter elements also being deployable. For example, the American patent U.S. Pat. No. 6,477,912 is known which describes a mechanical system for controlling a plate which, for example, may be a telescope secondary mirror.

Active control systems for correction often use wavefront reconstruction algorithms. For example, the American patent U.S. Pat. No. 4,309,602 may be mentioned which describes a control solution for an optical system using, for example, an algorithm for wavefront reconstruction by phase diversity.

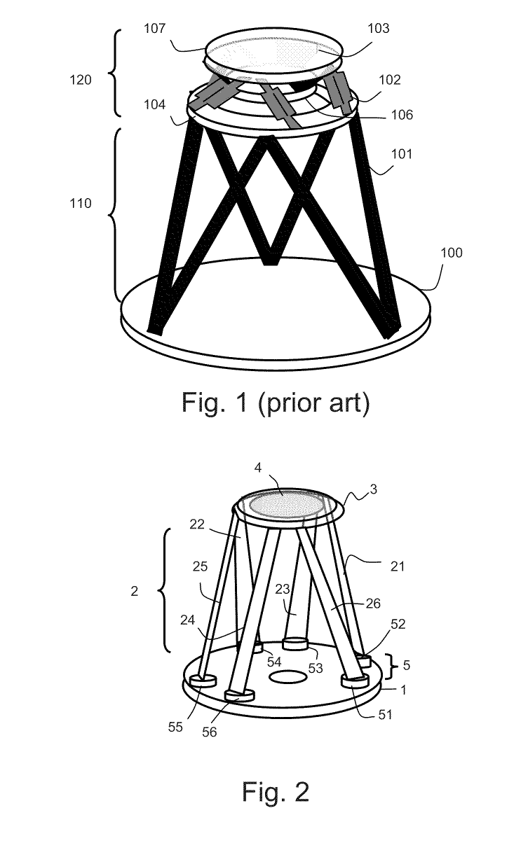

FIG. 1 represents a simplified diagram of an existing space telescope, having a primary mirror and a secondary mirror 106. The primary mirror (not shown) is positioned on a supporting base 100, and the secondary mirror 106 is supported by a first mechanical structure 110 which is non-deployable and immobile, comprising three pairs of mechanical arms 101 and intended to separate the secondary mirror from the primary mirror, and by a second mechanical structure consisting of mechanical elements 103 connecting the secondary mirror 106 to a plate 107. The position of the secondary mirror is modified by the actuators 102 by displacing the plate 107. The plate 107, the secondary mirror 106, the actuators 102 and the second mechanical structure form the hexapod structure 120 allowing the position of the secondary mirror to be modified. This hexapod also includes the electronic systems for supply, control, etc. This latter solution, although it does make it possible to correct the position and the orientation of the secondary mirror, induces an increase in mass at a position separated from the centre of gravity of the optical system. This configuration reduces the agility of the system and lowers the vibration frequencies of the first natural modes of the telescope. Furthermore, this increase in mass at the secondary mirror requires an increase in the rigidity of the structure so as to be able to withstand the accelerations during the take-off phase, and consequently an increase in the mass of the structure.

The French patent 2628670 in the name of INRIA (Institut National de Recherche en Informatique et en Automatique) is known, describing an articulated device for the field of robotics, in particular for the design of a robot hand or alternatively for the design of a flight simulator. This articulated device allows high positioning accuracy.

It is an object of the invention to overcome the drawbacks of the solutions mentioned above and to provide an optical system having means for active control of the optics of greater scope, presenting better performance and withstanding the stresses of space use.

More precisely, the invention relates to an optical space observation system comprising at least a primary mirror, a secondary mirror, a supporting base containing the primary mirror, on which a mechanical structure bearing a support of the secondary mirror is positioned, and an optoelectronic measurement means, said mechanical structure comprising a plurality of mechanical arms and the optoelectronic measurement means capturing images acquired by the optical space observation system. The optical space observation system according to the invention is characterized:
in that it has a calculation means calculating data for correcting the positioning of the secondary mirror on the basis of data delivered by the optoelectronic measurement means,
in that it also has a system comprising a plurality of actuators positioned on the supporting base, said actuators being connected to the lower ends of said mechanical arms and the upper ends of said mechanical arms being connected to the support of the secondary mirror on the periphery of the support,
and in that the positioning of the secondary mirror is adjusted by means of actuators displacing the lower ends of said mechanical arms on a translation path as a function of the correction data.

During the correction phase, the length of a mechanical arm is constant and the secondary mirror is immobile on its support.

The invention is advantageous because the part dedicated to the electronic and mechanical means of the active the control system for the optics of the telescope is positioned on the supporting base. The mass is thus principally distributed over the base and the centre of gravity is therefore lowered.

In a first embodiment, the mechanical structure bearing the support of the secondary mirror is a deployable structure such that in a first configuration the support of the mirror rests directly on the supporting base and, in a second configuration, the support of the mirror is in a position separated from the supporting base.

Since the structure of the telescope no longer has the system of actuators at the secondary mirror, the solution facilitates the use of a telescope structure with a deployable architecture of the secondary mirror, for the reason that the mechanical structure can be designed with fewer dimensional stability constraints. This is because the adjustments of the telescope are carried out in orbit. Advantageously, the optical system also exhibits better agility because the structure bearing the secondary mirror has less mass.

The dimensions of the space telescope can also be increased, thus making it possible to design more highly performing optical systems.

Advantageously, the space telescope can be installed inside a spacecraft and the mechanical structure is configured in said first position when the system is installed in said spacecraft, and in said second position when the system is in observation mode. The deployable structure reduces the bulk of the optical system and consequently makes it possible to transport a larger number of systems inside the launcher.

In a second embodiment, the mechanical structure is a non-deployable architecture. Since the electronics and mechanics for controlling the secondary mirror are positioned on the supporting base, the upper part of the telescope for the support of the secondary mirror can be adapted easily to the supporting base.

In both embodiments, the invention is advantageous because the mechanical architecture makes the design and development of the optical system more flexible than a solution with the active control system at the secondary mirror. Specifically, the solution makes it possible to use an architecture with a deployable or non-deployable secondary mirror. The supporting base constitutes a standardized mechanical base for a secondary mirror support.

In a preferred embodiment, the system of actuators has actuators with translation axes perpendicular to the upper plane of the supporting base. The system of actuators has six actuators distributed over the periphery of the supporting base in order to displace the support of the secondary mirror in six degrees of freedom. For this embodiment, the mechanical structure bearing the support of the mirror preferably has six mechanical arms, the length of which is equal to approximately one meter.

For the production of an autocorrected space telescope according to the invention, the optical measurement means, the calculation means and the system of actuators constitute an active control chain for correcting the positioning of the secondary mirror in order to adjust the observation configuration of the optical system.

Preferably, the calculation means compiles the positioning corrections of the secondary mirror by means of a wavefront reconstruction algorithm, and the system of actuators and the mechanical structure bearing the support of the secondary mirror constitute mechanical means intended to introduce defects on the measured images. The on-board active control system determines the positioning corrections to be provided at a given position on the basis of telescope image measurements. The invention avoids the use of meteorological systems coupled to the structure. This provides simplification of the systems for the telescope, in cost and in mass.

The invention will be better understood, and other advantages will become apparent, on reading the following description given nonlimitingly and by virtue of the appended figures, in which:

FIG. 1 represents a simplified diagram of an existing solution for an autocorrected space telescope having a hexapod for control of the secondary mirror at the secondary mirror.

FIG. 2 represents a simplified diagram of a preferred embodiment of the mechanical structure and the system of actuators for a hexapod of a telescope having a primary mirror and a secondary mirror. For the sake of clarity, the other elements of the telescope are not represented. The secondary mirror is positioned in a first position in which the actuators have the same configuration.

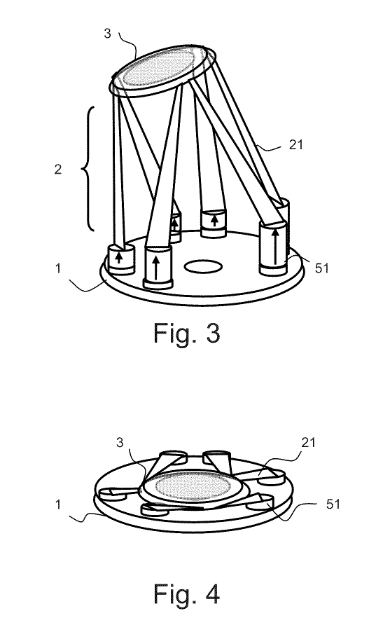

FIG. 3 represents a simplified structure of the same mechanical structure and the system of actuators with the secondary mirror in a second position. The actuators are controlled in order to be positioned in different configurations. The representation of the displacement value ranges of the actuators in the figure is also a simplified representation.

FIG. 4 represents a simplified diagram of the same mechanical structure. The mechanical structure is deployable and illustrates the system in a position in which the secondary mirror rests directly on the supporting base.

It is an object of the invention to make it possible to reduce the mass of an optical system of the space telescope type and to improve the agility of the optical system, in particular for an optical system having a secondary mirror which may be deployable. The invention is not, however, limited to optical systems with a deployable mechanical structure. Specifically, one advantage of the invention is the design flexibility of the optical system, the supporting base forming a standard mechanical and control element on which the structure bearing the secondary mirror is carried.

To this end, the invention as described by FIGS. 2 and 3 relates to the mechanical structure of a high-resolution space telescope having a primary mirror and a secondary mirror 4.

FIG. 2 represents a simplified diagram of the mechanical structure of the space telescope with default positioning of the secondary mirror. Each of the actuators controlling the positioning of the mirror is in the same inactive position. The primary mirror is not represented for the sake of clarity; it is positioned in the upper plane of the supporting base 1. The support 3 of the secondary mirror 4 is carried by a mechanical structure 2 on the supporting base 1, said supporting base 1 making it possible to control the positioning of the secondary mirror 4 by means of a system of actuators 5 executing a translation movement perpendicular to the upper plane of the supporting base 1. The system of actuators 5 has 6 actuators distributed over the periphery of the supporting base. The movement is carried out on the lower end of each arm 21 to 26 of the mechanical structure.

During the operational phase of the space optical system when the satellite is in orbit, said operational phase comprising the observation phases and the phases of correcting the observation by modifying the positioning of the secondary mirror, the length of the mechanical arms 21 to 26 is constant. The secondary mirror must be far enough away from the primary mirror so that the focal plane of the images corresponds to the detection plane of the image detection means of the optoelectronic measurement means. Preferably, the length of the mechanical arms in the operating configuration is about one meter. If the mechanical structure 2 is deployable, the length of said arms may be variable during the phase of putting the optical system into operation. This phase generally takes place after the satellite has separated from the launcher and been put into orbit. If the satellite does not have a deployable secondary mirror structure, the length of the arms is identical irrespective of the operational phase. The choice of a deployment embodiment of the mechanical structure 2 does not limit the scope of the invention.

The supporting base 1 also includes the system for active control of the optics of the telescope. The figures do not represent the electronic calculation and control means for the sake of clarity. An optical measurement means, a calculation means and the system of actuators 5 constitute an active control chain for correcting the positioning of the mirror 4 in order to adjust the observation configuration of the space telescope. The optoelectronic measurement means generally consists of high-resolution electronic sensors, for example of the CCD type (Charge-Coupled Device). These sensors are positioned in the focal plane of the telescope. The calculation means carries out image processing operations, on the basis of which data for correcting the positioning of the secondary mirror 4 are compiled.

In another embodiment, the optical system includes the electronics and the means for controlling the secondary mirror, while the calculation means are located on the ground. The satellite carrying the optical system then also has means of communication with the ground in order to receive the correction data.

The image processing functions for calculating the positioning corrections of the secondary mirror are preferably based on wavefront reconstruction algorithms. By way of nonlimiting example, phase diversity algorithms may be mentioned. The documents cited in the prior art describe the methods of calculation by wavefront analysis. The phase reconstruction consists in extracting the information about the optical aberrations of the instrument, which are contained in the image, by using numerical inversion methods. There are a plurality of methods and hardware configurations for carrying out the calculations.

The principle of compiling corrections by wavefront analysis should be recalled. This principle consists in evaluating positioning defects of the secondary mirror via their impact on the image. On the basis of an optical sensitivity matrix of the system, determined at the time of designing the optical system, the effects of the misalignment of the secondary mirror on the aberrations detected in the images are known. By applying the inverse matrix to the images, the distance of which from the focal plane is known, it is possible to recover an evaluation of the misalignment of the secondary mirror and therefore an evaluation of the corrections to be made.

In order to measure images having defects due to misalignment with the focal plane, these defects are either introduced by additional mechanical means, for example a means for displacing the image detector, or by introducing an additional optical plate or by displacing the secondary mirror. Preferably, the invention compiles the positioning corrections of the secondary mirror by displacing the mirror to a known position introducing defects on the recorded image. Nevertheless, the method of introducing defects on the image in no way limits the scope and spirit of the invention.

By the phase diversity method, the positioning of the secondary mirror can be adjusted iteratively in order to approach an optimal observation position. The method of measuring images and correcting the positioning of the secondary mirror is carried out following the take-off phase of the launcher, but also at multiple times in the mission so as to ensure optimal performance of the telescope when confronted with ageing phenomena of the structure and/or its materials.

FIG. 3 represents a simplified diagram of the optical system in a configuration in which the mirror is misaligned so that an image detected on the measurement means has defects. The positioning of the secondary mirror is modified by translational movement of the actuators 51 to 56 located on the supporting base 1. Each actuator displaces the lower end of a mechanical arm perpendicularly to the upper plane of the supporting base 1. The displacement value range of the lower end of a mechanical arm is approximately a few centimeters. The mechanical structure 2 comprises mechanical arms 21 to 26, and each of the mechanical arms comprises a pivot connection or a rotary connection at one of its ends and a rotary connection at its other end, these rotary connections joining on the one hand a mechanical arm to the support 3 of the secondary mirror and on the other hand said mechanical arm to the actuator of the supporting base. The connections may be formed in various ways: by using elements such as universal joints, rolling bearings, bearing elements, but also flexible elements or the flexibility of the arms themselves. The length of the arms remains constant. This mechanical architecture thus makes it possible to displace the orientation of the secondary mirror in 6 degrees of freedom.

The calculation means compiling the correction data for positioning the secondary mirror transmits these corrections to a control system of the system of actuators 5. This control system converts the correction data for positioning the secondary mirror into control data for each of the actuators 51 to 56, said actuators carrying out altitude positioning modifications of the bases of the mechanical arms. The purpose of the control law of the actuators is to convert the instructions for positioning the secondary mirror into altitude positioning of the actuators 51 to 56.

The electronics and the mechanical means for controlling the optics are positioned on a support base. The secondary structure 2 and 3 bearing the secondary mirror 4 is preferably designed with mechanical elements characterized by low passive dimensional stability requirements in comparison with a mechanical architecture which is adjusted on the ground, given that the optical adjustment is carried out in orbit. Once in orbit, this structure does not experience strong mechanical stresses. This latter structure is also more agile, the energy required for modifying the configuration of said structure is also less and the displacements are more precise. Overall, with a system of actuators positioned on the supporting base, the optical system has a system for autocorrection of the positioning of the secondary mirror which performs better in precision and in correction efficiency.

FIG. 4 represents a mechanical structure bearing the support of the deployable mirror such that the support of the secondary mirror rests directly on the supporting base 1 in a first position. Thus, the space telescope is installed inside a spacecraft and the mechanical structure is configured in said first position when the system is installed in said spacecraft. The deployable structure reduces the bulk of the optical system and therefore makes it possible to transport a larger number of systems inside the launcher.

The invention is intended in particular for space telescopes with active control of the optics. The algorithms for controlling the secondary mirror which have been described, merely by way of example, are based on algorithms with wavefront reconstruction by phase diversity. Nevertheless, the invention includes all variants which the person skilled in the art may envisage without departing from the appended claims.

The invention also preferably relates to telescopes with a deployable secondary mirror, but is not limited to this type of architecture.

1. An optical space observation system comprising:
at least a primary mirror,
a secondary mirror,
a supporting base containing the primary mirror, on which a mechanical structure bearing a support of the secondary mirror is positioned, and an optoelectronic measurement means, said mechanical structure comprising a plurality of mechanical arms and the optoelectronic measurement means capturing images acquired by the optical space observation system,
a calculation means for calculating data for correcting the positioning of the secondary mirror on the basis of data delivered by the optoelectronic measurement means,
a plurality of actuators positioned on the supporting base, said actuators being connected to the lower ends of said mechanical arms and the upper ends of said mechanical arms being connected to the support of the secondary mirror on the periphery of the support,
wherein the positioning of the secondary mirror is adjusted by means of actuators displacing the lower ends of said mechanical arms on a translation path as a function of the correction data, the optical measurement means, the calculation means and the system of actuators constituting an active control chain for correcting the positioning of the secondary mirror in order to adjust the observation configuration of the optical system.

2. The system according to claim 1, wherein the length of the mechanical arms is constant during the correction phase.

3. The system according to claim 2, wherein the calculation means compiles the positioning corrections of the secondary mirror by means of a wavefront reconstruction algorithm.

4. The system according to claim 3, wherein the system of actuators and the mechanical structure bearing the support of the secondary mirror constitute mechanical means intended to introduce defects on the measured images.

5. The system according to claim 1, wherein the mechanical structure bearing the support of the secondary mirror is a deployable structure such that in a first configuration the support of the mirror rests directly on the supporting base and, in a second configuration, the support of the mirror is in a position separated from the supporting base.

6. The system according to claim 5, wherein the system is installed inside a spacecraft and the mechanical structure is configured in said first configuration when the system is installed in said spacecraft, and in said second configuration when the system is in observation mode.

7. The system according to claim 1, wherein the system of actuators has actuators with translation axes perpendicular to the upper plane of the supporting base.

8. The system according to claim 7, wherein the system of actuators has six actuators distributed over the periphery of the supporting base in order to displace the support of the secondary mirror in six degrees of freedom.

9. The system according to claim 8, wherein the mechanical structure bearing the support of the mirror has six mechanical arms.

10. The system according to claim 9, wherein the secondary mirror is immobile on the support.
